(19) United States
(12) Patent Application Publication
(10) Pub. No.: US 2026/0250997 A1
(43) Pub. Date: Aug. 27, 2026

(54) DOOR CLOSER

(71) Applicant: Polaris IP Pty Ltd, West Gosford NSW (AU)

(72) Inventor: Michael Christopher STUART, West Gosford NSW (AU)

(73) Assignee: Polaris IP Pty Ltd, West Gosford NSW (AU)

(21) Appl. No.: 19/160,355

(22) PCT Filed: Feb. 27, 2024
(86) PCT No.: PCT/AU2024/050158

§ 371 Date: Aug. 27, 2025

(30) Foreign Application Priority Data
Feb. 27, 2023 (AU) AU2023900505

(51) Int. Cl. E05F 1/00

(52) U.S. Cl. CPC E05F 1/00; E05Y 2201/412; E05Y 2201/46; E05Y 2600/12; E05Y 2900/132

(57) ABSTRACT

A door closer including: a first assembly including a first magnet mountable to a first portion of door assembly; a second assembly mountable to a second portion of a door assembly, wherein the first portion is movable relative to the second door assembly, wherein the second assembly includes: a second assembly frame; a second magnet mountable to the second assembly frame such that a closing force is created between the first magnet and the second magnet when the door is adjacent to a closed position; wherein the second assembly includes a second assembly mounting plate having an adjustment slot with two or more mounting positions for the second assembly frame, each mounting position being a different distance relative to the first magnet, such that a magnitude of the closing force is adjusted by the mounting position of the second assembly frame. Also, a combination of door closer and installation guide.

### RELATED APPLICATIONS

The present application claims priority to Australian Provisional Application No. 2023900505, filed 27 Feb. 2023. The content of the above-referenced application(s) is hereby incorporated by reference in entirety.

### FIELD

The present invention relates to a door closer.

### BACKGROUND

Some doors may include features that may result in incomplete closure of the door. For example, some doors may include dampeners and the closing force of the door may be insufficient to overcome the spring force of the dampener. Other doors may include security features, such as a latch that must be overcome to secure the door, and the closing force of the door may be insufficient to overcome the latch.

An existing approach to these problems is to simply increase the closing force of the door, however this has undesirable effects, such as increasing the closing speed of the door to unsafe levels, or imparting an excess of momentum on the door which will result the door slamming through the security latch causing excess noise. Many in the industry will be familiar with the security door that closes slowly, only to the rapidly, and noisily, crash into the latch to overcome the securing forces of the latch.

### SUMMARY

It is an object of the present invention to at least substantially address one or more of the above disadvantages, or at least provide a useful alternative.

In a first aspect there is provided a door closer for use with a door assembly having a door mounted to a door frame, the door closer including: a first assembly including a first magnet mountable to a first portion of door assembly; a second assembly mountable to a second portion of a door assembly, wherein the first portion is movable relative to the second door assembly, wherein the second assembly includes: a second assembly frame; a second magnet mountable to the second assembly frame such that a closing force is created between the first magnet and the second magnet when the door is adjacent to a closed position; wherein the second assembly includes a second assembly mounting plate having an adjustment slot with two or more mounting positions for the second assembly frame, each mounting position being a different distance relative to the first magnet, such that a magnitude of the closing force is adjusted by the mounting position of the second assembly frame.

In one or more embodiments, at least one of the first and second assembly each include a mounting pad for supporting the respective assembly against the first or second portion of the door assembly.

In one or more embodiments, the mounting pad of at least one of the first assembly and the second assembly is formed from a material that is softer than the first and second structure.

In one or more embodiments, the second assembly mounting plate includes a first hole for receiving a fine adjustment fastener, the fine adjustment fastener of the second assembly being configured to apply a retaining force between the second assembly mounting plate and the second assembly frame, such that movement of the second assembly frame is inhibited by the retaining force.

In one or more embodiments, the second assembly mounting plate includes a set of mounting holes for receiving fasteners to mount the second assembly mounting plate to the second portion of the door assembly.

In one or more embodiments, the second assembly includes a mounting stud to engage the mounting position in the adjustment slot.

In one or more embodiments, the mounting stud has a width that is greater than a width of the adjustment slot, and the mounting positions in the adjustment slot have a width that is about the same as the width of the mounting stud.

In one or more embodiments, the mounting stud has a circular profile and the mounting positions include recesses having portions of a matching circular profile to retain the mounting stud.

In one or more embodiments, the door closer further includes a cover for covering the second assembly, the cover for covering the second assembly having a snap-fit that engages the second assembly frame to retain the cover.

In one or more embodiments, the cover for the second assembly has a face that, when mounted to the second assembly and the door is in the closed position, is positioned between the first magnet and the second magnet.

In one or more embodiments, the face has a material thickness of about 0.5 mm to 4 mm.

In one or more embodiments, the face has a material thickness of about 1.5 mm to 3 mm.

In one or more embodiments, the face has a material thickness of about 2.25 mm.

In one or more embodiments, the first assembly further includes a first assembly frame, wherein the first magnet is mountable to the first assembly frame.

In one or more embodiments, the first assembly includes a first assembly mounting plate having an adjustment slot with two or more mounting positions for the first assembly frame, each mounting position being a different distance relative to the second magnet, such that a magnitude of the closing force is adjusted by the mounting position of the first assembly frame.

In one or more embodiments, the first assembly mounting plate includes a first hole for receiving a fine adjustment fastener, the fine adjustment fastener being configured to apply a retaining force between the first assembly mounting plate and the first assembly frame, such that movement of the first assembly frame is inhibited by the retaining force.

In one or more embodiments, the first assembly mounting plate includes a set of mounting holes for receiving fasteners to mount the first assembly mounting plate to the first portion of the door assembly.

In one or more embodiments, the first assembly includes a mounting stud to engage the mounting position in the adjustment slot.

In one or more embodiments, the mounting stud has a width that is greater than a width of the adjustment slot, and the mounting positions in the adjustment slot have a width that is about the same as the width of the mounting stud.

In one or more embodiments, the mounting stud has a circular profile and the mounting positions include recesses having portions of a matching circular profile to retain the mounting stud.

In one or more embodiments, the door closer further includes a cover for covering the first assembly, the cover having a snap-fit that engages the first assembly frame to retain the cover.

In one or more embodiments, the cover has a face that, when mounted to the first assembly and the door is in the closed position, is positioned between the first magnet and the second magnet.

In one or more embodiments, the face has a material thickness of about 0.5 mm to 4 mm.

In one or more embodiments, the face has a material thickness of about 1.5 mm to 3 mm.

In one or more embodiments, the face has a material thickness of about 2.25 mm.

In a second aspect, there is provided in combination, a door closer for use with a door mounted to a door frame, and an installation guide, the door closer being configured according to the first aspect or an embodiment thereof, and the installation guide having: a frame; and a separation face located in the frame that is located between the first assembly and the second assembly, such that, when the first assembly has been mounted to the first portion of the door assembly and the second assembly has been mounted to the second portion of the door assembly, the installation guide is removable to leave an air gap between the first assembly and the second assembly.

In one or more embodiments, the separation face has a thickness of about 0.5 mm to 4 mm.

In one or more embodiments, the separation face has a thickness of about 1 mm to 3 mm.

In one or more embodiments, the separation face has a thickness of about 2 mm.

In one or more embodiments, the frame includes one or more legs that engage a side of each of the first assembly and the second assembly to urge the first and second assembly to be in a parallel orientation.

In one or more embodiments, the frame includes extrusions on a surface orthogonal to the separation face to enable grippable removal of the frame when the first assembly and the second assembly have been mounted.

Other aspects and embodiments will be appreciated throughout the description of the examples.

### BRIEF DESCRIPTION OF THE FIGURES

Preferred embodiments will now be described by way of example, with reference to the accompanying figures:

FIG. 1 is a perspective view of an example of a door closer.

FIG. 2 is a perspective view of the door closer of FIG. 1, having the covers removed.

FIG. 3 is an exploded view of the door closer of FIG. 1.

FIG. 3A is a detailed view of a frame of the door closer of FIG. 1.

FIG. 4 is a side view of the door closer of FIG. 1.

FIG. 5 is a section view along section A-A of FIG. 4 of the door closer of FIG. 1.

FIG. 6 is a top view of the door closer of FIG. 1.

FIG. 7 is a perspective section view along section B-B of FIG. 6 of the door closer of FIG. 1.

FIG. 8 is a perspective view of a combination of the door closer of FIG. 1 with an example of an installation guide.

FIG. 9 is a bottom perspective view of the combination of FIG. 8.

FIG. 10 is an in-situ view of the combination of FIG. 8.

FIG. 11 is an in-situ view of the door closer of FIG. 1 after installation, without the cover installed.

FIG. 12 is an in-situ view of the door closer of FIG. 1, after the covers have been installed.

FIG. 13 is a perspective view of a further example of a door closer.

FIG. 14 is a perspective view of the door closer of FIG. 13, having the covers removed.

FIG. 15 is an exploded view of the door closer of FIG. 13.

FIG. 16 is a side view of the door closer of FIG. 13.

FIG. 17 is a section view along section C-C of FIG. 16 of the door closer of FIG. 13.

FIG. 18 is a top view of the door closer of FIG. 13.

FIG. 19 is a perspective section view along section D-D of FIG. 18 of the door closer of FIG. 13.

FIG. 20 is a perspective view of a combination of the door closer of FIG. 13 with an example of an installation guide.

FIG. 21 is a bottom perspective view of the combination of FIG. 20.

FIG. 22 is an in-situ view of the combination of FIG. 20.

FIG. 23 is an in-situ view of the door closer of FIG. 13 after installation, without the cover installed.

FIG. 24 is an in-situ view of the door closer of FIG. 13, after the covers have been installed.

### DETAILED DESCRIPTION

The following description, given by way of example only, is intended to provide a more precise understanding of the subject matter of a preferred embodiment or embodiments. In the figures, incorporated to illustrate features of an example embodiment, like reference numerals are used to identify like parts throughout the figures.

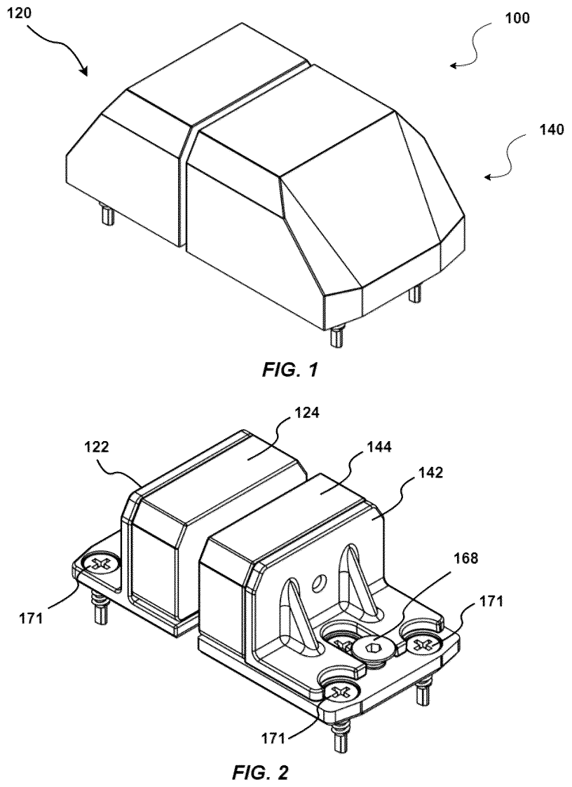

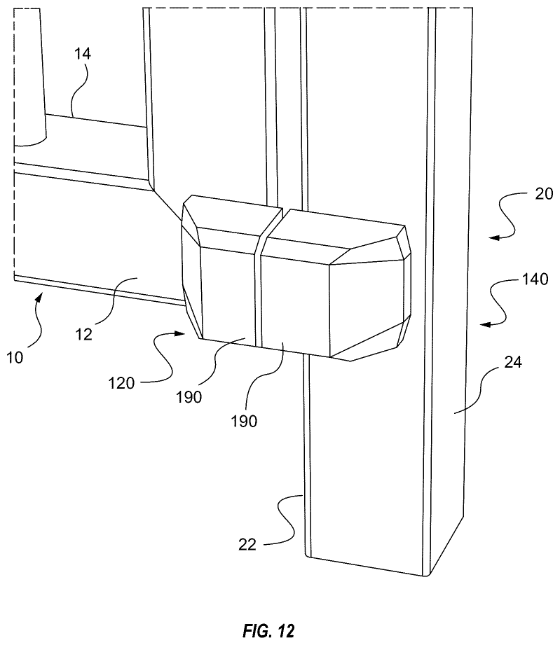

FIG. 1 shows a door closer 100 according to a preferred embodiment of the invention. As shown in FIG. 12, the door closer 100 is for use with door assembly including a first portion movable to a second portion. The door assembly includes a door frame 20 having a door 10 mounted thereto. The door 10 has a front surface 12 and a rear surface 14. The door frame 20 similarly has a front surface 22 and a rear surface 24. The first portion of the door assembly can be the door or the door frame, and the second portion of the door assembly can be the opposite portion.

As shown in FIG. 2, the door closer 100 includes a first assembly 120 and a second assembly 140. In this example, the first assembly 120 can configured for attachment to the door 10 while the second assembly 140 can be configured for attachment to the door frame 20. However, in practice the assemblies 120, 140 are interchangeable and could be mounted vice-versa. As shown in FIG. 12, the first assembly 120 can be configured to be attached to the front surface 12 of the door 10, though the rear surface 14 could also be used. Similarly, the second assembly 140 can be configured to be attached to the front surface 22 of the door frame 20, though the rear surface 24 could also be used.

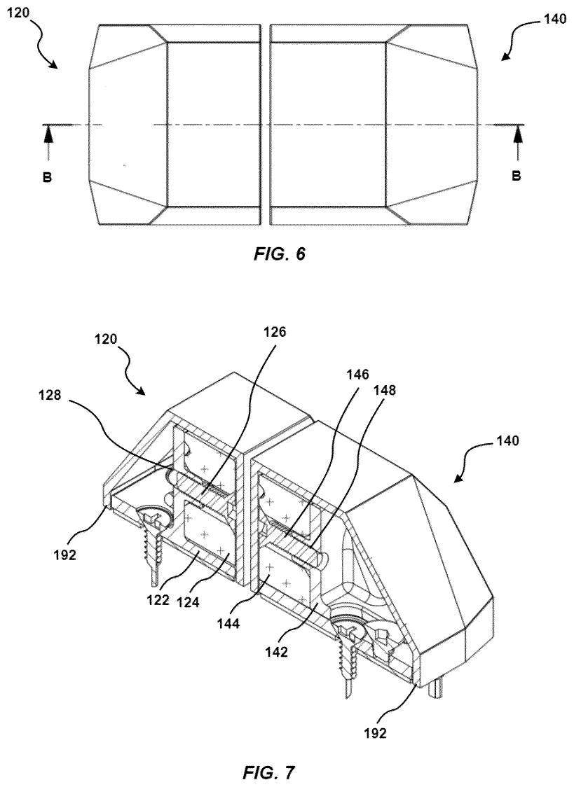

As shown in FIGS. 4 to 7, the first assembly 120 includes a first structure 122, provided in the form of a first assembly frame, and a first magnet 124 mounted to the first assembly frame 122. The magnet 124 is preferably mounted to the first assembly frame 122 using a fastener 126 interacting with a tapped hole 128. In one embodiment, the first magnet 124 may include a permanent magnet, while in another embodiment the first magnet 124 may include an electromagnet. As shown in the figures, the first magnet 124 can include a hole 129 that projects therethrough to allow securing of the first magnet 124 to the first assembly frame 122.

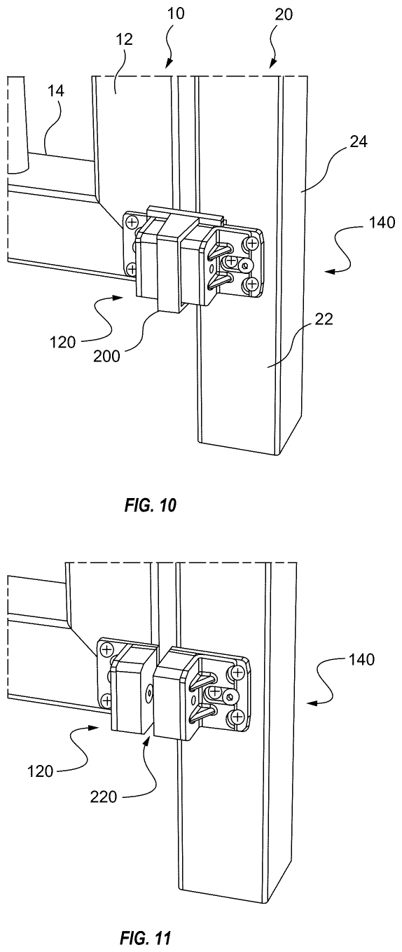

The second assembly 140 similarly includes a second structure 142, provided in the form of a second assembly frame 142, and a second magnet 144 mounted to the second assembly frame 142. The magnet 144 is preferably mounted to the second assembly frame 142 using a fastener 146 interacting with a tapped hole 148. In one embodiment, the second magnet 144 may include a permanent magnet, while in another embodiment the second magnet 144 may include an electromagnet. The second magnet 144 is mounted such that a closing force is created between the first magnet 124 and the second magnet 144 when the door 10 is adjacent to a closed position, as shown in FIGS. 10 to 12. As shown in the figures, the second magnet 144 can include a hole 149 that projects therethrough to allow securing of the second magnet 144 to the second assembly frame 142.

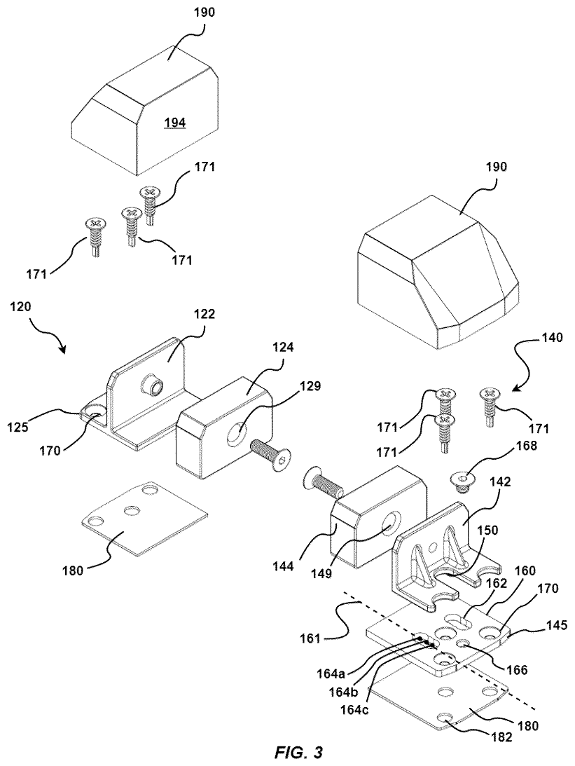

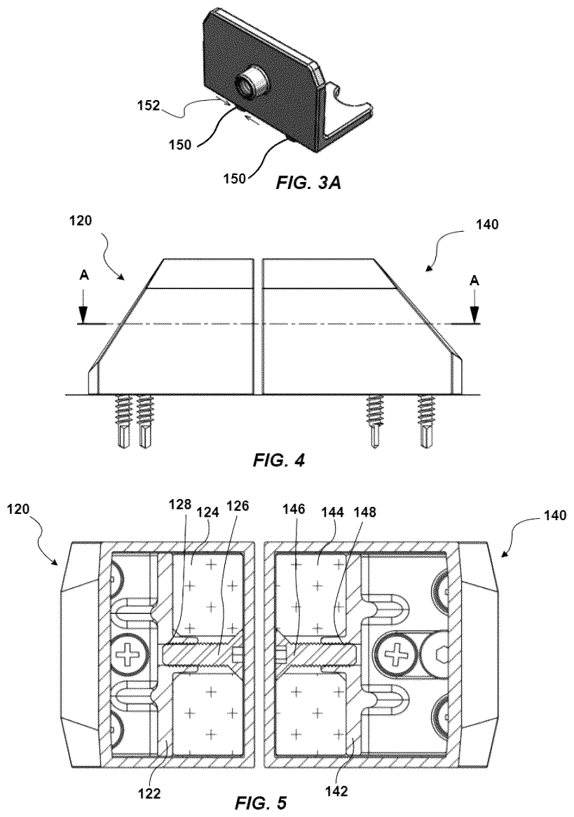

As seen in FIG. 3, the second assembly 140 includes a mounting plate 160. However, in other embodiments both assemblies 120, 140 may include the mounting plate 160, or only the second assembly 140 may include the mounting plate 160. The disclosure in this specification will be referring to the second assembly 140 and its components but it will be appreciated that this disclosure can similarly extend to the first assembly 120 and its components for the embodiment of FIG. 1.

The mounting plate 160 of the second assembly 140 includes an adjustment slot 162 extending along an adjustment axis 161 that extends at least partially along a similar direction to the closing force created between the first magnet 124 and the second magnet 144. The adjustment slot 162 includes a first mounting position 164a, a second mounting position 164b, and a third mounting position 164c. However, it will be appreciated that any number of mounting positions 164 could be used, including a continuously adjustable adjustment slot 162. The mounting positions 164 are configured to be used to mount the second assembly frame 142. Accordingly, the second assembly frame 142 may include a mounting stud 150, as shown in FIG. 3A, to engage the mounting position in the adjustment slot 162. The mounting positions 164 are located at different distances relative to the second assembly frame 142, such that a magnitude of the closing force is adjusted by the mounting position 164 in which the second assembly frame 142 is mounted.

The mounting stud 150 preferably has a width 152 that is greater than a width of the adjustment slot 162. The mounting positions 164 preferably have a width that is about the same as the width 152 of the mounting stud 150, so that once the mounting stud 150 is located in the desired mounting position 164, movement of the mounting stud 150 relative to the adjustment slot 162 is inhibited. Preferably, the mounting stud 150 has a circular profile and the mounting positions 164 each include a recess that includes portions of a circular profile that matches the circular profile of the mounting stud 150 to retain the mounting stud 150 in the recess.

The mounting plate 160 preferably includes a set of mounting holes 170 for mounting the second assembly 140 to the door frame 20 using a set of fasteners 171. If the second assembly 140 does not include a mounting plate 160, the second assembly frame 142 includes a similar set of mounting holes 170 for mounting the second assembly 140 to the second portion of the door assembly using a similar set of fasteners 171.

The first assembly 120 of FIG. 1 preferably includes a mounting pad 180 located between the first assembly frame 122 and the first portion of the door assembly. The second assembly 140 similarly preferably includes a similar mounting pad 180 located between the second assembly frame 142 and the door frame 20. The mounting pad 180 is preferably formed from a material that is softer than the material of the respective frame 122, 142 to help protect the frames 122, 142 and surfaces 12, 22 from damage. Preferably the material of the mounting pad 180 is an elastomer, such as rubber. Preferably, the mounting pad 180 includes a set of thruholes 182 that match the mounting holes 170 to allow the fasteners 171 to pass through the mounting pad 180 and mount the respective assembly 120, 140 to the respective portion of the door assembly. If the respective assembly 120, 140 does not include a mounting plate 160, the length of the assembly 120, 140 is shorter than the assembly 120, 140 that includes the mounting plate 160, as the full length of the adjustment slot 162 does not need to be accommodated.

Accordingly, the set of mounting holes 170 in the first frame 122 may have a shorter total extent in the adjustment axis 161 than the set of mounting holes 170 in the mounting plate 160.

Staying with FIG. 3, the mounting plate 160 may include a first hole 166, that is preferably tapped, for receiving a fine adjustment fastener 168. The fine adjustment fastener 168 is configured to apply a retaining force between the mounting plate 160 and the first assembly frame 142, such that movement of the second assembly frame 142 relative to the mounting plate 160 is inhibited by the retaining force. As seen in FIG. 3, the mounting pad 180 does not include a thruhole for the fine adjustment fastener 168, so that the fine adjustment fastener 168 abuts the elastic material of the mounting pad 180 for creating the retaining force, rather than damaging the front surface 22 of the first portion of the door assembly.

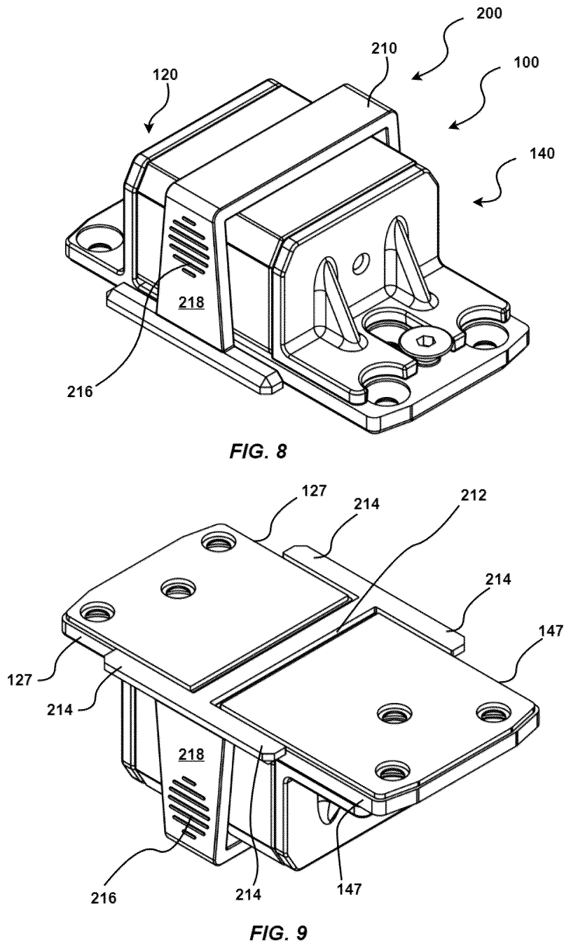

As also seen in FIG. 3, the door closer 100 further includes a cover 190 for covering the first assembly 120 and/or the second assembly 140. Preferably a separate cover 190 is provided for each assembly 120, 140. The cover 190 includes a snap-fit feature 192, as shown in FIG. 7, that engages a perimeter 125, 145 of the respective frame 120, 140 of the assembly 120, 140 to which the cover 190 is being engaged. The snap-fit 192 ensures that a minimum force is required to remove the cover 190 from the respective assembly 120, 140, so that the cover 190 can assist with protecting the assembly 120, 140 from the elements. The cover 190 includes a face 194 that, when the cover 190 is mounted to the respective assembly 120, 140, and the door 10 is in the closed position, is positioned between the first magnet 124 and the second magnet 144. The face 194 may have a material thickness of 0.5 mm to 4 mm, preferably 1.5 mm to 3 mm, most preferably about 2.25 mm.

As shown in FIGS. 8 and 9, the door closer 100 may be provided in combination with an installation guide 200. The installation guide 200 includes a frame 210 and a separation face 212. The separation face 212 is located in the frame 210 and situated so that it is located between the first assembly 120 and the second assembly 140, more preferably between the first magnet 124 and the second magnet 144 to prevent the magnets 124, 144 from snapping together. In this way, once the first assembly 120 has been mounted to the first portion of the door assembly and the second assembly 140 has been mounted to the second portion of the door assembly, as shown in FIG. 10, the installation guide 200 is removable to leave an air gap 220 between the first assembly 120 and the second assembly 140, as shown in FIG. 11. It is preferred that during any adjustment of the first assembly frame 142 along the adjustment slot 162, whether using the fine adjustment fastener 168 or the mounting positions 164, the installation guide is in place to prevent accidental snapping together of the magnets 124, 144.

Industrial strength magnets, once snapped together, can be very difficult to separate, and a personal injury hazard. Once the installation guide 200 has been removed, the covers 190 may be snapped onto the assemblies 120, 140, as shown in FIG. 12.

The separation face 212 may have a thickness of 0.5 mm to 4 mm, preferably 1 mm to 3 mm, most preferably about 2 mm. In the most preferred embodiment, the distance between the magnet 124 and the magnet 144 is set at about 6.5 mm, which in testing has shown to provide a desirable middle ground between consistent closing force imparted on the door 10, and an avoidance of over-force causing undesirable noise. However, individual circumstances may require the adjustment of this balance, which may be achieved by adjustment of this distance using the adjustment slot 162, the mounting studs 150, and the fine adjustment fastener 168.

As seen in FIG. 9, the installation guide 200 may further include one or more legs 214 that engage a side 127, 147 of each assembly 120, 140. The engagement of the legs 214 with the sides 127, 147 urges the assembles 120, 140 to remain in parallel orientation relative to each other. The installation guide 200 may further include extrusions 216 on a surface 218 orthogonal to the separation face 212 to improve grip on the frame 210 for removing the frame 210 when the first assembly 120 and the second assembly 140 have been mounted. While the assemblies 120, 140 have been mounted in these positions, significant closing force is still exerted between the magnets 124, 144, causing significant friction between the assemblies 120, 140 and the installation guide 200 that must be overcome to remove the installation guide 200.

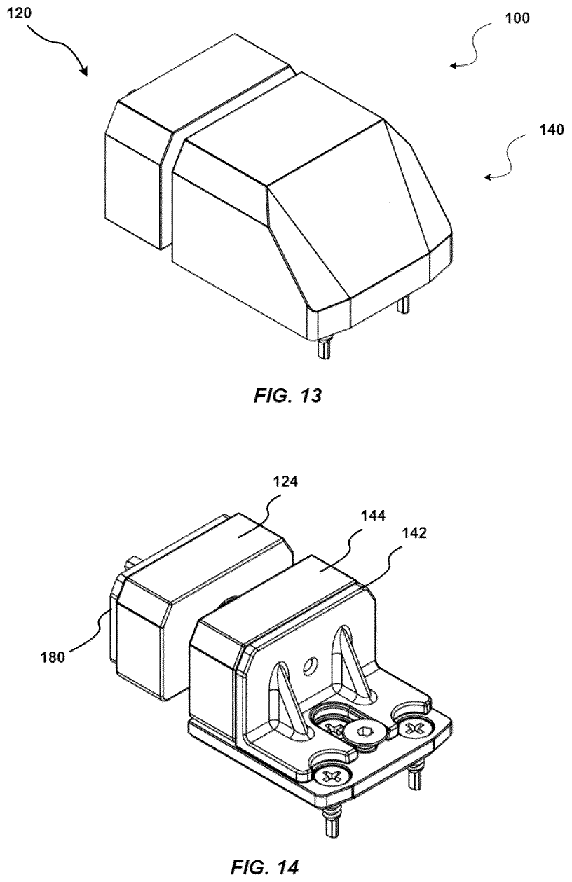

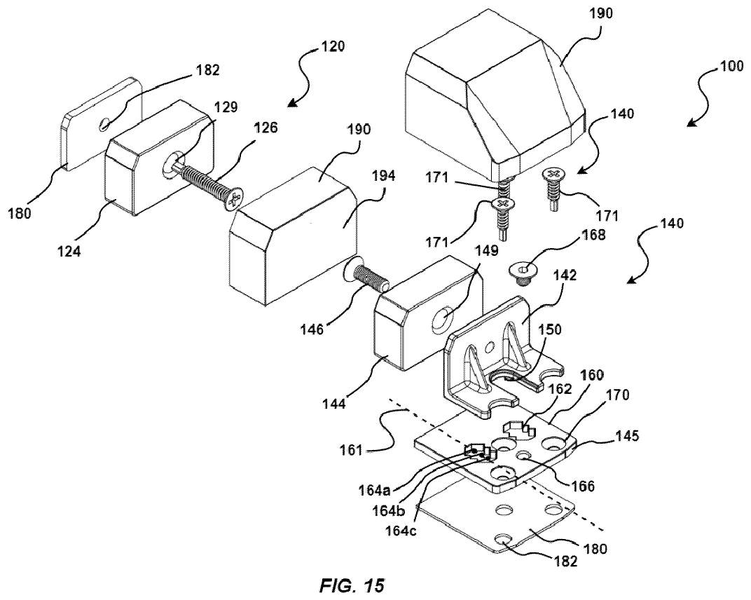

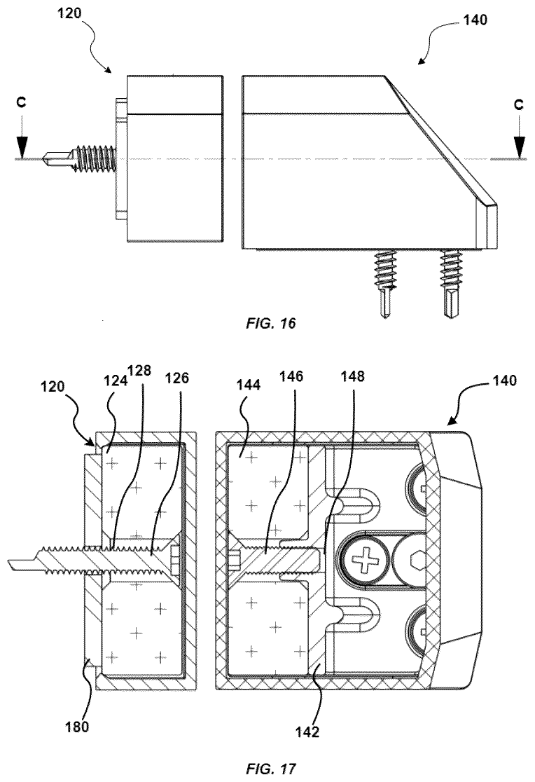

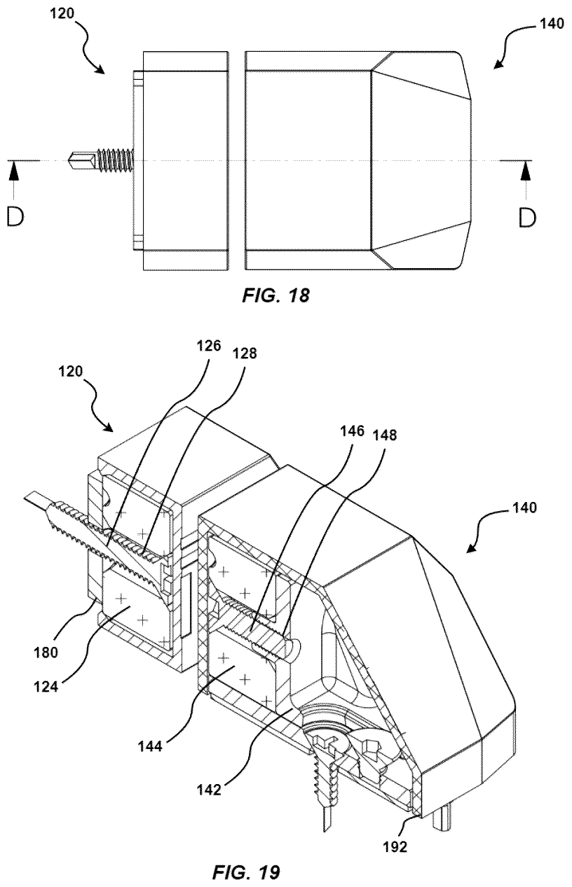

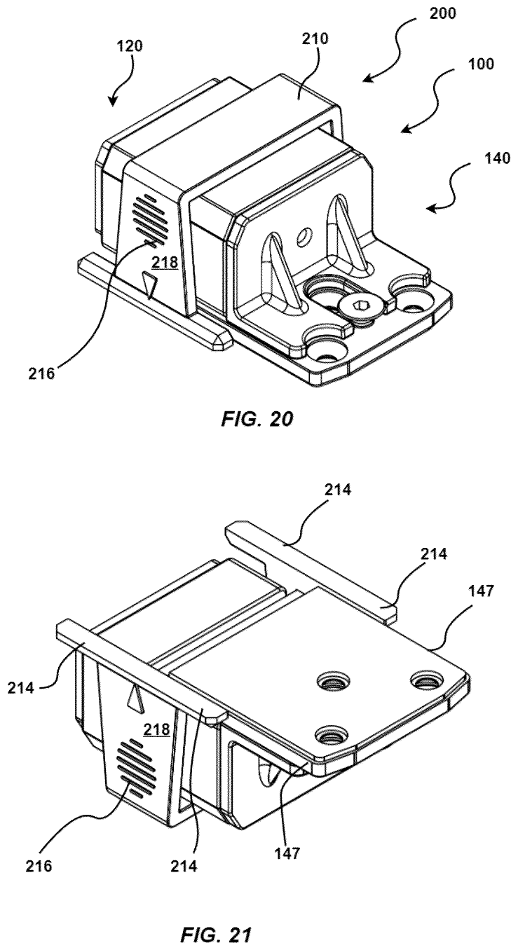

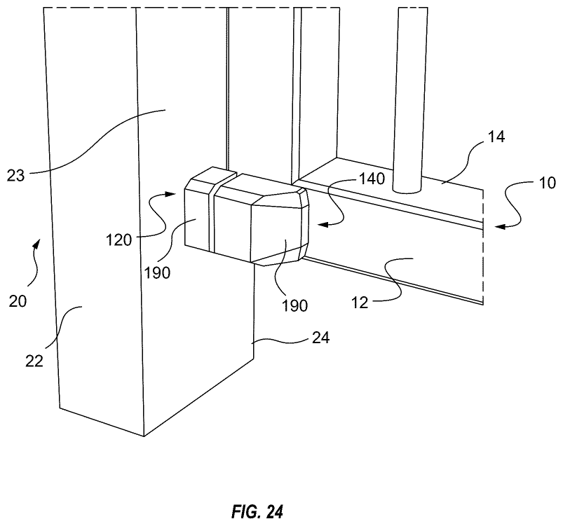

Referring to FIG. 13 there is shown an alternate example of a door closer 100. As shown in FIG. 24 the first assembly 120 is preferably configured to be attached to the first portion of the door assembly which in this example is a side surface 23 of the door frame 20. As shown in FIG. 15, the first assembly 120 includes a magnet 124, a mounting pad 122, a fastener 126, and a cover 190. The magnet 124 includes a hole 129 passing through the centre thereof which aligns with a hole 170 in the mounting pad 122 such that a fastener 126 can project therethrough, as shown in FIG. 16 and FIG. 17, to secure the first assembly 120 to the side surface 23 of the door frame 20. The cover 190 has a snap fit 192 configuration to secure the cover 190 to the magnet 144 as shown in FIGS. 18 and 19. As can be seen in FIGS. 13 to 19, the second assembly 140 is configured in the same manner as the second assembly 140 described above in relation to the embodiment of FIG. 1.

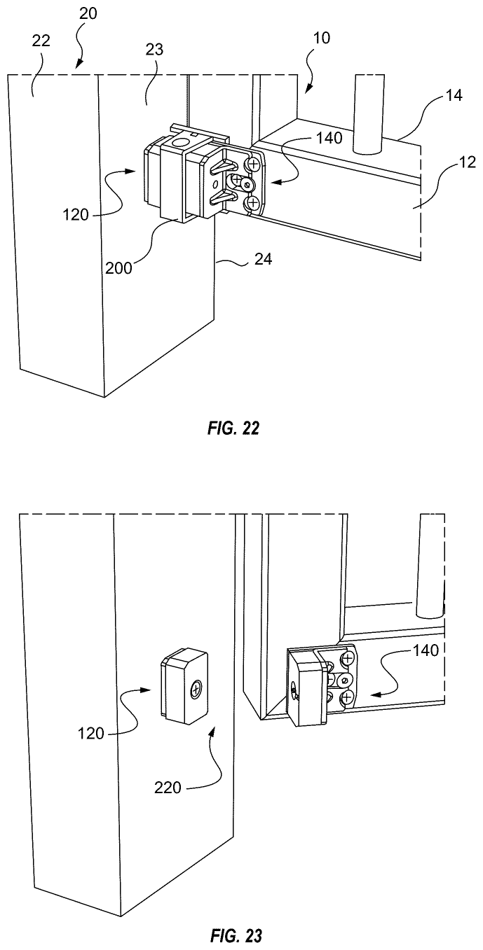

Referring to FIGS. 20 and 21, there is shown a combination of a door closer 100 and installation guide 200 which is configured in substantially the same manner as described in relation to FIGS. 8 and 9. The door closer 100 can be installed in a similar manner as described in relation to FIGS. 10 to 12. In particular, referring to FIG. 22, the first assembly 120 is initially mounted to the side surface 23 of the door frame 20 and the second assembly 140 is mounted to the door 10, as shown in FIG. 22, wherein the installation guide 200 is removable, as shown in FIG. 23 to leave an air gap 220 between the first assembly 120 and the second assembly 140, as shown in FIG. 23. It is preferred that during any adjustment of the second assembly frame 142 along the adjustment slot 162, whether using the fine adjustment fastener 168 or the mounting positions 164, the installation guide 200 is in place to prevent accidental snapping together of the magnets 124, 144. Industrial strength magnets, once snapped together, can be very difficult to separate, and a personal injury hazard. Once the installation guide 200 has been removed, the covers 190 may be snapped onto the assemblies 120, 140, as shown in FIG. 24.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above-described invention.

In this specification, the terms ‘comprises’, ‘comprising’, ‘includes’, ‘including’, or similar terms are intended to mean a non-exclusive inclusion, such that a method, system, or apparatus that comprises a list of elements does not include those elements solely but may well include other elements not listed.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

### INTEGERS

10 door
12 front surface
14 rear surface
20 door frame
22 front surface
23 side surface
24 rear surface
100 door closer
120 first assembly
122 first assembly frame
124 first magnet
125 perimeter of first assembly frame
126 fastener
127 side
128 tapped hole
129 hole in first magnet
140 second assembly
142 second assembly frame
144 second magnet
145 perimeter of second assembly frame
146 fastener
147 side
148 tapped hole
149 hole is second magnet
150 mounting stud
160 mounting plate
161 adjustment axis
162 adjustment slot
164x mounting positions
166 first hole
168 fine adjustment fastener
170 mounting holes
171 fastener
180 mounting pad
182 thruholes
190 cover
192 snap-fit
194 face
200 installation guide
210 frame
212 separation face
214 legs
216 extrusions 218 surface 220 air gap

1. A door closer for use with a door assembly having a door mounted to a door frame, the door closer including:
a first assembly including a first magnet mountable to a first portion of door assembly;
a second assembly mountable to a second portion of a door assembly, wherein the first portion is movable relative to the second door assembly, wherein the second assembly includes:
a second assembly frame;
a second magnet mountable to the second assembly frame such that a closing force is created between the first magnet and the second magnet when the door is adjacent to a closed position;
wherein the second assembly includes a second assembly mounting plate having an adjustment slot with two or more mounting positions for the second assembly frame, each mounting position being a different distance relative to the first magnet, such that a magnitude of the closing force is adjusted by the mounting position of the second assembly frame, wherein the second assembly mounting plate includes a first hole for receiving a fine adjustment fastener, the fine adjustment fastener of the second assembly being configured to apply a retaining force between the second assembly mounting plate and the second assembly frame, such that movement of the second assembly frame is inhibited by the retaining force.

2. The door closer of claim 1, wherein at least one of the first and second assembly each include a mounting pad for supporting the respective assembly against the first or second portion of the door assembly.

3. The door closer of claim 2, wherein the mounting pad of at least one of the first assembly and the second assembly is formed from a material that is softer than the first and second structure.

4. (canceled)

5. The door closer of claim 1, wherein the second assembly mounting plate includes a set of mounting holes for receiving fasteners to mount the second assembly mounting plate to the second portion of the door assembly.

6. The door closer of claim 1, wherein the second assembly includes a mounting stud to engage the mounting position in the adjustment slot.

7. The door closer of claim 6, wherein the mounting stud has a width that is greater than a width of the adjustment slot, and the mounting positions in the adjustment slot have a width that is about the same as the width of the mounting stud.

8. The door closer of claim 6, wherein the mounting stud has a circular profile and the mounting positions include recesses having portions of a matching circular profile to retain the mounting stud.

9. The door closer of claim 1, wherein the door closer further includes a cover for covering the second assembly, the cover for covering the second assembly having a snap-fit that engages the second assembly frame to retain the cover.

10. The door closer of claim 9, wherein the cover for the second assembly has a face that, when mounted to the second assembly and the door is in the closed position, is positioned between the first magnet and the second magnet.

11. (canceled)

12. (canceled)

13. (canceled)

14. The door closer of claim 1, wherein the first assembly further includes a first assembly frame, wherein the first magnet is mountable to the first assembly frame.

15. The door closer of claim 14, wherein the first assembly includes a first assembly mounting plate having an adjustment slot with two or more mounting positions for the first assembly frame, each mounting position being a different distance relative to the second magnet, such that a magnitude of the closing force is adjusted by the mounting position of the first assembly frame.

16. The door closer of claim 15, wherein the first assembly mounting plate includes a first hole for receiving a fine adjustment fastener, the fine adjustment fastener being configured to apply a retaining force between the first assembly mounting plate and the first assembly frame, such that movement of the first assembly frame is inhibited by the retaining force.

17. The door closer of claim 16, wherein the first assembly mounting plate includes a set of mounting holes for receiving fasteners to mount the first assembly mounting plate to the first portion of the door assembly.

18. The door closer of claim 1, wherein the first assembly includes a mounting stud to engage the mounting position in the adjustment slot.

19. The door closer of claim 18, wherein the mounting stud has a width that is greater than a width of the adjustment slot, and the mounting positions in the adjustment slot have a width that is about the same as the width of the mounting stud.

20. The door closer of claim 18, wherein the mounting stud has a circular profile and the mounting positions include recesses having portions of a matching circular profile to retain the mounting stud.

21. The door closer of claim 14, wherein the door closer further includes a cover for covering the first assembly, the cover having a snap-fit that engages the first assembly frame to retain the cover.

22. The door closer of claim 22, wherein the cover has a face that, when mounted to the first assembly and the door is in the closed position, is positioned between the first magnet and the second magnet.

23. (canceled)

24. (canceled)

25. (canceled)

26. In combination, a door closer for use with a door mounted to a door frame, and an installation guide, the door closer being configured according to claim 1, and the installation guide having:
a frame; and
a separation face located in the frame that is located between the first assembly and the second assembly, such that, when the first assembly has been mounted to the first portion of the door assembly and the second assembly has been mounted to the second portion of the door assembly, the installation guide is removable to leave an air gap between the first assembly and the second assembly.

27. (canceled)

28. (canceled)

29. (canceled)

30. The combination of claim 26, wherein the frame includes one or more legs that engage a side of each of the first assembly and the second assembly to urge the first and second assembly to be in a parallel orientation.

31. (canceled)
